(19) United States
(12) Patent Application Publication
(10) Pub. No.: US 2011/0213788 A1
(43) Pub. Date: Sep. 1, 2011

(54) INFORMATION FUSION FOR MULTIPLE ANOMALY DETECTION SYSTEMS

(75) Inventors: YING ZHAO, Cupertino, CA (US); Charles Chuxin Zhou, Cupertino, CA (US); Chetan K. Kotak, San Jose, CA (US)

(73) Assignee: QUANTUM INTELLIGENCE, INC., Cupertino, CA (US)

(21) Appl. No.: 13/103,121

(22) Filed: May 9, 2011

Related U.S. Application Data
(63) Continuation of application No. 12/042,338, filed on Mar. 5, 2008.

(51) Int. Cl. G06F 17/30

(52) U.S. Cl. 707/751; 707/E17.044; 707/E17.122

(57) ABSTRACT

The present invention is a method for detecting anomalies against normal profiles and for fusing and visualizing the results from multiple anomaly detection systems in a quantifying and unifying user interface. The knowledge patterns discovered from historical data serve as the normal profiles, or baselines or references (hereinafter, called “normal profiles”). The method assesses a piece of information against a collection of the normal profiles and decides how anomalous it is. The normal profiles are calculated from historical data sources, and stored in a collection of mining models. Multiple anomaly detection systems generate a collection of mining models using multiple data sources. When a piece of information is newly observed, the method measures the degree of correlation between the observed information and the normal profiles. The analysis is expressed and visualized through anomaly scores and critical event notifications that are triggered by fusion rules, thus allowing a user to see multiple levels of complexity and detail in a single view.

### CROSS-REFERENCE TO RELATED APPLICATIONS

This is a continuation of patent application series No. 12/042,338, Filed on Mar. 5, 2008. The benefit of patent application Ser. No. 12/042,338, under 35 U.S.C. 119(e), is hereby claimed.

### FEDERALLY SPONSORED RESEARCH

N/A

### SEQUENCE LISTING

NONE

### REFERENCES

[1] S. Rubin, M. Christodorescu, V. Ganapathy, J. T. Giffin, L. Kruger, H. Wang and N. Kidd. “An Auctioning Reputation System Based on Anomaly Detection”. In ACM CCS'05, Nov. 7-11, 2005.
[2] P. Varner and J. C. Knight, “Security Monitoring, Visualization, and System Survivability”, Information Survivability Workshop, January 2001.
[3] M. Luis, A. Bettencourt, R. M. Ribeiro, G. Chowell, T. Lant and C. Castillo-Chavez, “Towards Real Time Epidemiology: Data Assimilation, Modeling and Anomaly Detection of Health Surveillance Data Streams”, Lecture Notes in Computer Science, Springer Berlin/Heidelberg, 2007
[4] R. K. Gopal, and S. K. Meher, “A Rule-based Approach for Anomaly Detection in Subscriber Usage Pattern”, International Journal of Mathematical, Physical and Engineering Sciences. Volume 1 Number 3.
[5] S. Sarah, “Competitive Overview of Statistical Anomaly Detection”, White Paper, Juniper Networks, 2004
[6] P. Laskov, K. Rieck, C. Schafer, K. R. Müller, “Visualization of Anomaly Detection Using Prediction Sensitivity”, Proc. of Sicherheit, April 2005, P. 197-208.
[7] K. Labib, V. R. Vemuri, “Anomaly Detection Using S Language Framework: Clustering and Visualization of Intrusive Attacks on Computer Systems”. Fourth Conference on Security and Network Architectures, SAR'05, Batz sur Mer, France, June 2005
[8] F. Mizoguchi, “Anomaly detection using visualization and machine learning”, Proceedings of IEEE 9th International Workshops on Enabling Technologies: Infrastructure for Collaborative Enterprises, 2000 P 165-170.
[9] X. Zhang, C. Gu, and J. Lin, “Support Vector Machines for Anomaly Detection”, The Sixth World Congress on Intelligent Control and Automation, P 2594-2598, 2006.
[10] C. Krügel, T. Toth, “Applying Mobile Agent Technology. to Intrusion Detection”, ICSE Workshop on Software Engineering and Mobility, Toronto May 2001
[11] C. A. Church, M. Govshteyn, C. D. Baker, C. D. Holm, “Threat Scoring System and Method for Intrusion Detection Security Networks”, US Patent Pub. No. US-2007/0169194 A1
[12] K. Bohacek, “Method, System and Computer-Readable Media for Reducing Undesired Intrusion Alarms in Electronic Communications Systems and Networks”, US Patent Pub. No. US-2008/0295172 A1

### BACKGROUND OF INVENTION

1. Field of Invention

The invention relates to a dynamic anomaly analysis of both structured and unstructured information. This invention also relates to the visualization of the analysis through anomaly scores from multiple anomaly detection systems and from critical event notifications triggered by fusion rules.

2. Related Art

Anomaly detection refers to identifying cases (records) that deviate from the norm in a dataset. Anomaly detection has been applied to many diversified fields, for example, fraud detection[1], intrusion detection in a computer network[2] and early event detection when monitoring health surveillance data streams[3]. An anomaly detection system typically requires historical data provided for a model building process that is able to extract normal profiles (Hereinafter, normal profiles also mean knowledge patterns, baselines or references) from which an anomaly detection is based upon. Applying the model to new data with similar schema and attribute content yields a probability that each case is normal or anomalous. Traditional methods include rule-based expert systems[4] to detect known system anomalies or on statistical anomaly detection to detect deviations from normal system activity[5].

Combining visual and automated data mining for anomaly detection is a new trend of the current art, for example, visualization combined using prediction sensitivity [6], clustering[7], machine learning[8], support vector machine [9], and mobile agent technologies[10].

Most of these systems worked well in a simulated environment; however, because anomalies in real-life are so sophisticated and evolve very rapidly, there are few deployable systems. The real challenge of anomaly detection is not increasing sensitivity to anomalies, but decreasing the number of false positives.

### SUMMARY OF THE INVENTION

The current anomaly detection systems tend to identify all possible anomalies instead of only the real anomalies. In other words, those systems usually have high false alarm rates. A high false alarm rate is the limiting factor for the performance of those anomaly systems. A solution to this problem lies in the application and visualization of data fusion techniques to aggregate multiple anomaly detection results into a single view and cross-validate to reduce the false alarm rates. The invention addresses this issue by using fusion rules and visualization techniques to combine the results from multiple anomaly detection systems. Fusion rules are decision support rules to fuse or combine anomaly detection results from multiple systems.

The invention allows for the analysis and quantification of information as it relates to a collection of normal profiles. More specifically, the invention allows information to be measured in terms of the level of anomaly with respect to multiple normal profiles. Normal profiles are knowledge patterns discovered from historical data sources. This measure or anomaly score is visualized in meters that allow for easy interpretation and updating. The method fuses the anomaly results from multiple detection systems and displays this data such that a human viewer can understand the real meaning of the results and quickly comprehend genuine anomaly activities. Furthermore, an analysis of information is accomplished through critical event notifications. Anomalies from separate systems are processed and evaluated against fusion rules, which trigger notification and visualization of only real anomaly events.

In the aspect of the invention, a method is provided for assessing a piece of information against normal profiles and deciding a level of anomalies, including:
Generating normal profiles from historical data sources
Storing the normal profiles in a collection of mining models
Comparing the information against the normal profiles
Generating anomaly scores
Triggering fusion rules
Displaying and categorizing critical events

Additional aspects of the invention, applications and advantages will be detailed in the following descriptions.

### BRIEF DESCRIPTION OF THE FIGURES/DRAWINGS

FIG. 1 is a flowchart describing the steps involved in analyzing and visualizing information for anomalies.

FIG. 2 is a block diagram representing a single anomaly detection system.

FIG. 3 is a diagram showing a network of anomaly detection systems.

FIG. 4 is a flowchart describing the steps taken by the critical event engine when evaluating an anomaly for critical events.

FIG. 5 is an illustration of the user interface for the present invention.

FIG. 6 is an illustration of one incarnation of an anomaly score visualization.

FIG. 7 is an illustration of one incarnation of a critical event visualization.

### DETAILED DESCRIPTION OF THE INVENTION

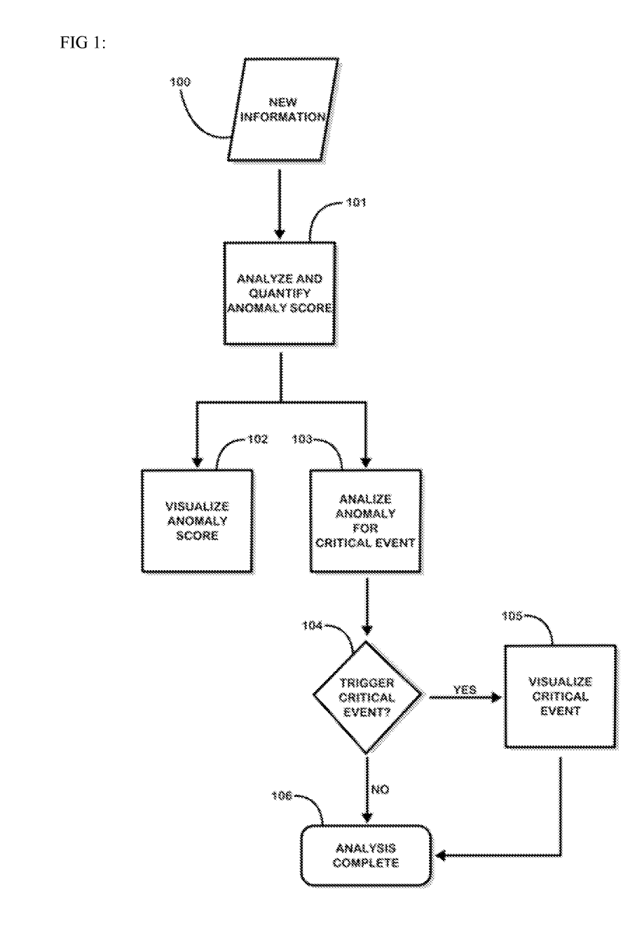

The present invention is used to analyze and assess information against how anomalous it is. The invention then allows for the assessment to be visualized through a user interface. FIG. 1 represents a flowchart diagram of the steps and processes involved in anomaly detection and visualization within a single anomaly detection system. New information 100 represents any form of structured and unstructured text and data that is to be processed by the system. The new information is passed to the anomaly detection engine, where it will be analyzed and the anomaly score will be determined 101. Upon completion, the score is wrapped in a meter object and is passed to the user interface for visualization 102. The anomaly score is further analyzed by the critical event engine to determine if any fusion rules have been triggered 103, 104. If a rule has been triggered, a critical event object is created and passed to the user interface for visualization 105. Finally, the process is complete 106.

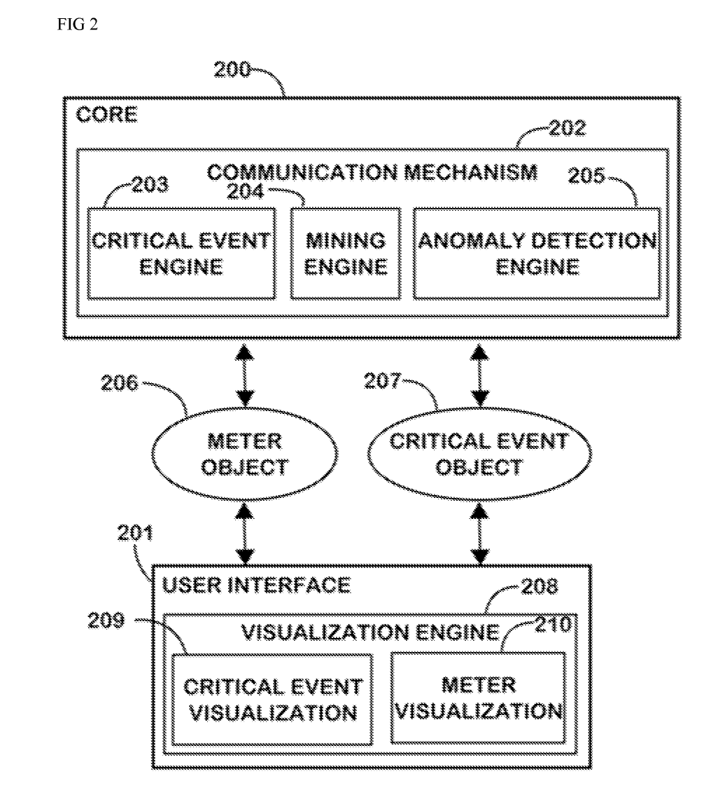

FIG. 2 is a block diagram representing a single anomaly detection system. The anomaly detection system is separated between the core 200 component and the user interface 201 component. The core component is responsible for the analysis and communication involved in determining the anomaly score of new information and for assessing whether or not information has triggered a critical event. All interactions between the core component and any other anomaly detection system is handled through a communication mechanism 202. Data passed to and from the anomaly detection system is encoded and decoded by the communication mechanism and then delegated to the proper component or to other anomaly detection systems.

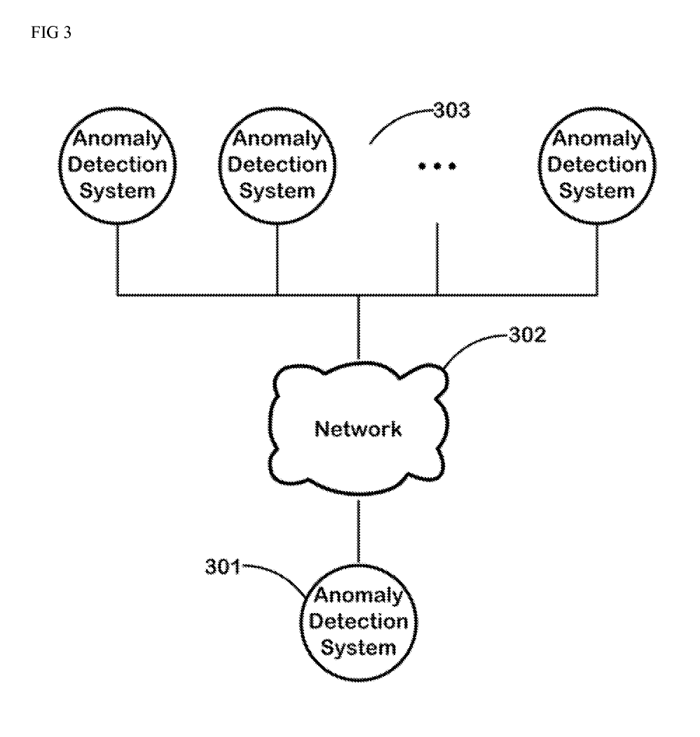

Multiple anomaly detection systems can be put on a network in order to assess new information against multiple normal profiles created by multiple data sources. Anomaly scores are fused from all anomaly detection systems on the network and applied against the fusion rules. FIG. 3 is a diagram of a network containing multiple anomaly detection systems. A source anomaly detection system 301 contacts multiple anomaly detection systems 303 across a network 302.

The mining engine 204 in FIG. 2 is responsible for the advanced data and text mining capabilities used in the anomaly detection system. This allows for the implementation of a single anomaly detection system that is trained from one data source and creates normal profiles. The anomaly detection system discovers normal knowledge patterns from its local domain and historical data. The discovered knowledge patterns are then stored locally in a mining model. These normal profiles are shared across multiple detection systems.

Application of the mining model and assessment of a piece of new information is handled by the anomaly detection engine 205. The new information is parsed and processed, where it can then be scored with an anomaly value. The anomaly value is a decimal number representing the degree of correlation the new information has to the normal profiles contained in the mining model. The score values range between 0 and 100, where a score of 0 indicates total unfamiliarity and 100 indicates total familiarity. Thus, a score of 0 can be interpreted as being an anomaly versus the normal profile. These anomaly score values are then placed into data objects called meter objects 206. Meter objects allow for anomaly scores to be represented structurally, providing a way for other components (e.g. the user interface) to interpret or visualize it.

Anomaly scores from the anomaly detection engine and from multiple detection systems are processed by the critical event engine 203. These scores are evaluated against a set of domain specific fusion rules. Fusion rules are expert rules for interpreting detection results from multiple systems. These rules can be set up to look for specific patterns and groupings, thus triggering critical event notifications, for example, a credit fraud event is notified when a large amount of charges occur in a short time frame. The critical event engine places the events in objects called critical event objects 207. Critical event objects allow for triggered events to be represented structurally, providing a way for other components (e.g. the user interface) to interpret or visualize it.

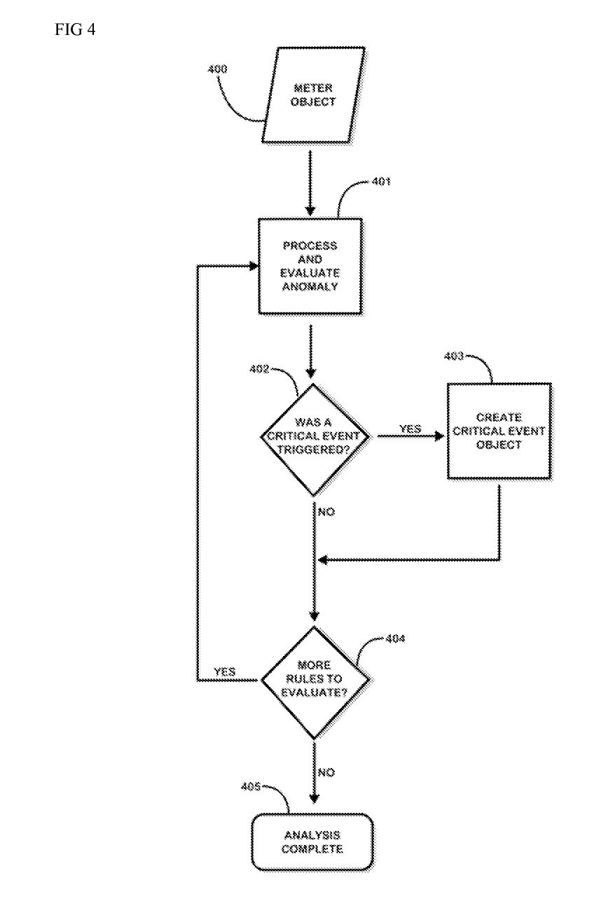

FIG. 4 is a flowchart representing the steps taken by the critical event engine when evaluating anomaly scores against the fusion rules. Meter objects 400 created by the anomaly detection engine and retrieved from other anomaly detection systems are processed and evaluated 401. A single fusion rule is tested to see if a critical event is triggered 402. If an event was triggered, a critical event object 403 is created in order to pass to the user interface or other components. As there may be multiple fusion rules available for evaluation, the engine checks to see if there are more rules left to evaluate 404. Once all the rules have been evaluated against the current anomaly scores, the process completes 405.

The meter object and the critical event object are data structures used to hold information representing the anomaly score and the critical event respectively. At a minimum, the meter object contains a reference to the information this meter object references and the calculated anomaly score. The anomaly detection engine creates the meter object for consumption by other components. At a minimum, a critical event object contains a reference to the information this critical event object references and the name of the critical event rule that was triggered. The data structures of both objects can be modified to accommodate the need for more detail.

All communication between the user interface 201 component and any other components in FIG. 2 is handled through the visualization engine 208. The visualization engine understands how to process data objects and to which components it needs to delegate visualization. The meter visualization 210 component handles the presentation of meter objects 206 to the user interface. The critical event visualization 209 component handles the presentation of critical event objects 207 to the user interface.

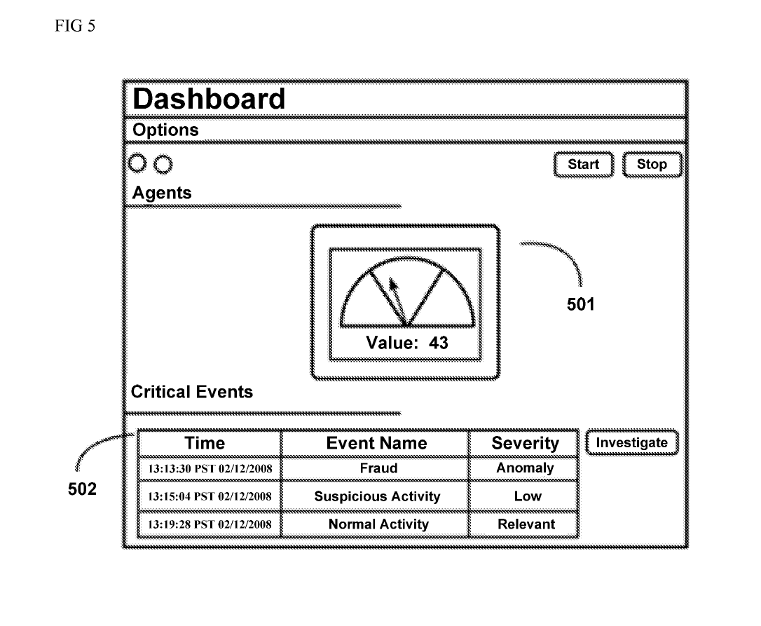

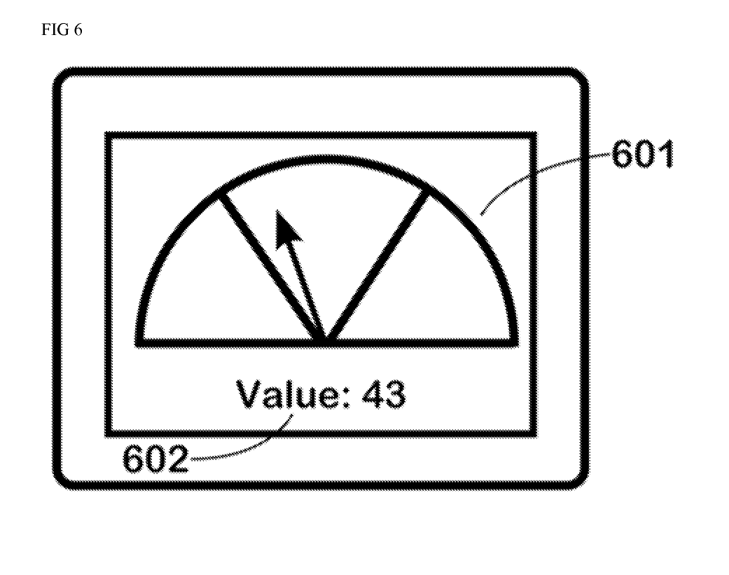

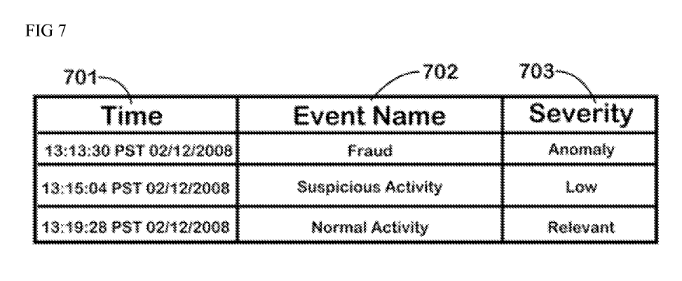

FIG. 5 illustrates one version of the user interface used to visualize anomalies. The interface includes two main sections: visualization of meter objects 501 and visualization of critical event objects 502. FIG. 6 is a detailed illustration of the visualization of a meter object. A gauge 601, 602 is used to visually represent the anomaly score of new information from an anomaly detection system. FIG. 7 is a detailed illustration of the visualization of a critical event object. Critical event notifications are displayed in a table structure, allowing for all events triggered by fusion rules to be explored. Detailed information of critical events, such as the time the rule was triggered 701, the critical event name 702, the severity or categorization of the critical event 703, and any other information stored in the critical event object can be displayed for analysis.

What is claimed:

1: A method for assessing a piece of information against a plurality of normal profiles and deciding a degree of anomalousness, where said method is performed by a computer comprises the steps of;
Generating said normal profiles comprising a plurality of mining models from historical data sources, wherein said data sources from a plurality of types of structured and unstructured data sources are presented in a unified format, wherein said generation is independent of the format and structure of said data sources and said generation is also independent of a plurality of data components and a plurality of application domains;
Deciding said degree of anomalousness being represented as an anomaly score, where said anomaly score is computed from the data components that are independent of application domains;
Fusing a plurality of anomaly scores from a network of anomaly detection systems through use of rules discovered from said data sources and previously unknown data components and factors of application domains, wherein said data sources are of cross-domain and said fusion rule is independent of any pre-defined rules from experts;
Triggering a critical event from the said fused scores from a network of anomaly detection systems, sorting and categorizing said critical events and pass them into a single visualization interface.

2: The method as recited in claim 1, wherein said normal profiles are generated from analyzing or mining historical data from a knowledge repository of structured or unstructured data sources or both, discovering knowledge patterns in a unified process, wherein examples of said structured data sources including data types from spreadsheets, databases and XML data, wherein examples of said unstructured data sources including free text input, word, html, pdf and ppt documents, wherein said unified process is used to represent said structured and unstructured data and input to said method separately or jointly, wherein said knowledge patterns are also called normal profiles, being stored within a collection of mining models, wherein said mining model is a mathematical model without predefined formula or pre-defined factors or attributes.

3: The method of claim 2, wherein said mining models are shared and accessed by a network of a plurality of anomaly detection systems powered by the said method, wherein each said anomaly detection system is dedicated to a single collection of said structured or unstructured data in a single application domain, wherein said mining model represents knowledge patterns discovered from said data collection in said domain, wherein said network, said data sources and said knowledge patterns can be of cross-domain in order to facilitate cross-validation of said knowledge patterns with the benefits to reduce false alarm rates, wherein said fusion rules of claim, independent of any application domains of said method, are applied to said network so that a collaborative decision of said degree of anomalousness in claim can be made, wherein said collaborative decision is dependent on new factors discovered from all the data in said cross domains and independent of pre-defined rules from any domain experts.

4: The method of claim 1, wherein said assessing a piece of information includes comparing it against said normal profiles in claim 1, calculating a degree of association or correlation said information with said normal profiles, and determining an anomaly score, wherein said anomaly score is a measure of distance of said information from existing knowledge represented in said normal files, wherein said anomaly score is data-driven, computed from previously unknown factors discovered from said data in said application domain in claim 1.

5: The method of claim 4, wherein assessing a piece of information includes calculating said anomaly scores, generating said collaborative decision from said network of systems and from said fusion rules for a piece of real-time information, wherein said real-time information comes from a plurality of search interfaces, a plurality of real-time data feed mechanisms or a plurality of data subscriptions.

6: A method of representing anomaly scores structurally easily for interpreting and visualizing the scores, wherein said method determines data-driven, previously unknown factors that have highest probability to trigger a critical event using said anomaly scores from said method in claim 4, wherein said previously unknown factors are discovered from the data dependent on application domains.

7: The method of claim 6, wherein triggering a critical event includes processing a network of said anomaly scores and decides which fusion rules being triggered, wherein said fusion rule is domain-specific, data-driven and derived from said knowledge patterns or normal profiles, wherein triggering a said rule includes first evaluating sequentially a large-scale collection of said normal profiles from a network of shared systems and anomaly scores and then forms a single fusion rule that triggers said critical event.

8: A method of recursively sorting critical events among said network of anomaly detection systems in claim 5 including creating a critical event object data structure that contains at least a reference to said information and said calculated anomaly score, categorizing critical events with a severity score attached to each category so that said sorting of said critical events can be done quickly and communicated among said network, wherein said severity score for said critical event category is computed from said fusion rules and said collaborative decisions, wherein final critical events in said data structures are passed a single interface that be invoked anywhere in said network for visualization, allowing for all triggered fusion rules said to be explored, involving, for example, the time a fusion rule is triggered, the critical event name, and said severity or categorization of the critical event.

9: The computer program that stores instructions executable by one or more processors to perform said method for assessing a piece of information against a plurality of said normal profiles and deciding a degree of anomalousness, fusing a plurality of said anomaly scores, independent of said pre-define expert rules and dependent of said previously unknown factors, from said network of anomaly detection systems, for analyzing said data sources of cross-domain, and generating said fusion rule independent of any pre-defined rules from experts, for applying said method to processing said real-time information, for triggering a critical event from the said sorting and categorizing of critical events and pass them into a single visualization interface in claim 8.
